(19) United States
(12) Patent Application Publication
(10) Pub. No.: US 2020/0234109 A1
(43) Pub. Date: Jul. 23, 2020

(54) Cognitive Mechanism for Social Engineering Communication Identification and Response

(71) Applicant: International Business Machines Corporation, Armonk, NY (US)

(72) Inventors: Taesung Lee, Ridgefield, CT (US); Youngja Park, Princeton, NJ (US)

(21) Appl. No.: 16/253,350

(22) Filed: Jan. 22, 2019

(51) Int. Cl. G06N 3/08; G06N 20/00

(52) U.S. Cl. CPC G06N 3/08; G06N 20/00

(57) ABSTRACT

Mechanisms for implementing a social engineering cognitive system are provided. The mechanisms train a social engineering classifier to classify documents in a corpus as to whether they are associated with a social engineering communication (SEC). The mechanisms process one or more documents of the corpus to classify the one or more documents as to whether the one or more documents are associated with an SEC to thereby identify a set of SEC related documents. The mechanisms extract key features from the documents in the set of SEC related documents. The mechanisms train an SEC classification model based on the extracted key features, which processes a newly received electronic communication to determine whether or not the newly received electronic communication is an SEC. The mechanisms perform a responsive action in response to determining that the newly received electronic communication is an SEC.

### BACKGROUND

The present application relates generally to an improved data processing apparatus and method and more specifically to mechanisms for providing cognitive identification of patterns of content of communications indicative of social engineering communications and providing responsive actions to communications containing such patterns.

Social engineering, in the context of information security, is the use of deception to manipulate individuals into divulging confidential or personal information that may be used for fraudulent purposes. The type of information that unscrupulous individuals and organizations are attempting to acquire varies, as does the techniques that these individuals use to acquire such information. For example, such personal information may include account numbers, social security numbers, passwords, etc. or may even include obtaining access to the user's computing device so that malicious software (malware) can be installed on the computing device giving the unscrupulous party access to passwords, account information, etc. or even control over the computing device itself. Moreover, the information includes the confidential information of an organization that the deceived individual has access to. Besides the information, social engineering can cause a certain action by the deceived individual or the organization, such as clicking a link, wire transferring money, and disabling the company network firewall.

Such social engineering attacks typically prey on human beings' good and not so good tendencies, e.g., desire to trust others, greed, etc. Such attacks can take many different forms including electronic mail communications that appear to come from persons that the recipient knows (e.g., a friend, relative, social website contact), trusted organizations or sources (e.g., well known sources such as the Internal Revenue Service, companies that the person does business with, etc.). Other types of social engineering attacks include baiting scenarios in which the unscrupulous party offers something that the recipient wants in response to the recipient clicking on a graphical user interface element or responding to the communication. Still other types of social engineering attacks may take the form of a communication claiming to be responding to a question that the recipient allegedly posed, even though the recipient may never have posed the question in the first place.

One type of social engineering attack that is common in modern communications is referred to as a phishing attack. With a phishing attack, the unscrupulous party (attacker) often claims to be a party that they are not in order to fool the recipient of the communication into opening the communication, an attachment to the communication, or the like, and thereby unknowingly cause malware to be installed on the recipient's computing device.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising at least one processor and at least one memory, the at least one memory comprising instructions executed by the at least one processor to cause the at least one processor to implement a social engineering cognitive system. The method comprises training, by the social engineering cognitive system, a social engineering classifier to classify documents in a corpus as to whether they are associated with a social engineering communication (SEC). The method further comprises processing, by the social engineering cognitive system, one or more documents of the corpus to classify the one or more documents as to whether the one or more documents are associated with an SEC to thereby identify a set of SEC related documents. In addition, the method comprises extracting, by the social engineering cognitive system, key features from the SEC related documents in the set of SEC related documents, and training, by the social engineering cognitive system, an SEC classification model based on the extracted key features. Moreover, the method comprises processing, by the trained SEC classification model, a newly received electronic communication to determine whether or not the newly received electronic communication is an SEC. The method also comprises performing, by a computing device, a responsive action in response to determining that the newly received electronic communication is an SEC.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram illustrating an interaction between functional elements of a social engineering communication (SEC) cognitive system in accordance with one illustrative embodiment;

FIG. 2A illustrates an example of content of a social engineering communication;

FIG. 2B illustrates an example of content of a SPAM communication;

FIG. 2C is an example diagram illustrating one type of document, e.g., posting, that may be analyzed by the social engineering classifier engine in accordance with one illustrative embodiment;

FIG. 2D is another example of a document that may be part of the corpus/corpora which may be analyzed to identify SECs and train a social engineering classification model with regard to key extracted features of such SECs in accordance with one illustrative embodiment;

FIG. 3 is an example diagram illustrating an example distributed data processing system environment in which one illustrative embodiment are implemented;

FIG. 4 is a block diagram of an example data processing system in which aspects of the illustrative embodiments are implemented;

FIG. 5 is a flowchart outlining an example operation for training and deploying a social engineering classification model in accordance with one illustrative embodiment; and

FIG. 6 is a flowchart outlining an example operation for executing a trained social engineering classification model and performing dynamic training of the model in accordance with one illustrative embodiment.

### DETAILED DESCRIPTION

The illustrative embodiments provide mechanisms for providing cognitive identification of patterns of content of communications indicative of social engineering communications and providing responsive actions to communications containing such patterns. The mechanisms of the illustrative embodiments apply the learned patterns to new communications to classify the communications as to whether they are likely social engineering communications or not. Such classification can then be used to perform a responsive action on the classified communications, e.g., flagging the communication as a social engineering communication, blocking the communication, sending the communication to an appropriate folder or storage location, reporting a source of the communication to a governmental regulation agency or other authorized individual or organization, etc. These responsive actions are generally directed to mitigating the negative effects of SECs with regard to the computing devices and/or users targeted by these SECs. It should be appreciated that the term “communications” as it is used herein refers to electronic communications of various types that are exchanged between computing devices and are intended for viewing by a user via a computing device and a corresponding computer application or user interface.

It should be appreciated that social engineering communications vary widely in their content, format, and other characteristics. Such social engineering communications often appear to be valid communications with regard to their content even though their content is crafted to elicit a response from the recipient that will involved disclosing personal information or performance of an action that will allow the unscrupulous source of the social engineering communication (referred to as the “attacker” hereafter) to gain access to personal information or to the recipient's computing device itself. That is, these social engineering communications try to mimic user dialogue or mentions to disguise an attack and avoid virus scanning and filtering mechanisms. Social engineering communications differ from other types of communications that may be more easily identified as unwanted by the recipient, such as SPAM communications, in that the social engineering communications have a personalized nature and attempt to appear as if they are valid communications between a person or organization that the recipient is familiar with and the content of the communication appears to be directed to a potentially valid issue. SPAM on the other hand is not personalized and is generally concerned with soliciting goods/services rather than attempting to obtain personal information of the recipient for unscrupulous reasons. Moreover, social engineering communications differ from other communications attempting to distribute computer viruses as such computer virus communications typically are attempting to have the user provide access to the computer for installation of virus software or code via computer virus attachments and the like, which can be scanned using virus scanning mechanisms and quickly identified and blocked.

Virus scanning mechanisms are not able to identify such social engineering communications as they may not contain indicators of viruses and, for all intents and purposes, appear to be valid communications from trusted sources until the recipient performs a responsive action, e.g., responding to the communication, clicking on a hyperlink or other graphical user interface element, or the like, at which point their unscrupulous intents are realized. Thus, virus scanning mechanisms, which use virus definitions to look for indicators of computer code being associated with communications, e.g., in attachments associated with communications, will not identify the social engineering communications as a threat.

Furthermore, filtering mechanisms, such as SPAM filters, may not be sufficient since such filtering mechanisms are reliant upon fixed elements of a communication, e.g., a particular source name, a particular source domain, a particular phrase in the subject line of the communication, or the distribution pattern such as thousands of users receiving the same message from a certain email address. As social engineering attackers are often sophisticated parties, they utilize many different methods to modify the elements that they know filtering mechanisms look for so that they can circumvent such filters. Moreover, since the social engineering message is highly personalized and often sent to one user, strong SPAM filtering features, such as the distribution features, cannot be used. Also, the message content features used by advanced SPAM filters often rely on words or phrases related to a certain action (e.g., selling a product). However, most social engineering communications have a completely different purpose and thus, have features that are hard to identify. To make matters worse, the contents of social engineering communications are often very similar or identical to legitimate emails with small tweaks.

Moreover, social engineering communication based attackers are changing the content of their social engineering communications and using various different techniques to attempt to get recipients to respond to such communications and provide them access to personal information and/or the computing device. For example, in one instance the attacker may pose as a valid company asking for a user to confirm information in an attempt to have the recipient or user respond and open the door to obtaining personal information either by providing it directly in the response or causing malware to be installed on the recipient's computing device which collects this personal information. In another instance, the attacker may allege that the user's account has been hacked and that they need to change their password in an attempt to have the user (recipient of the social engineering communication) enter their current password as part of a password change operation. Thus, looking for the former social engineering communication may not result in the latter being identified. Hence, the social engineering attacks are dynamically changing and thus, it is necessary to have a mechanism that can dynamically change with the changes in attacks so that they can be adequately thwarted.

The mechanisms of the illustrative embodiments leverage cognitive computing mechanisms to learn patterns of content of communications from a variety of different sources, which are indicative of social engineering communications, i.e. communications whose content is intended to manipulate individuals into divulging confidential or personal information that may be used for fraudulent purposes. These mechanisms may dynamically learn such patterns from the variety of different sources and apply the learned patterns to newly received communications to classify these newly received communications as to the likelihood that they are a social engineering communication or not. A responsive action may then be taken based on the classification.

As the illustrative embodiments utilize cognitive computing mechanisms to identify social engineering communications, it is beneficial to have an understanding or overview of how cognitive computing systems operate. As an overview, a cognitive computing system, or cognitive system, is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. A cognitive system performs one or more computer-implemented cognitive operations that approximate a human thought process as well as enable people and machines to interact in a more natural manner so as to extend and magnify human expertise and cognition. A cognitive system comprises artificial intelligence logic, such as natural language processing (NLP) based logic, for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, intelligent search algorithms, such as Internet web page searches, for example, recommendation generation, e.g., items of interest to a particular user, potential new contact recommendations, or the like. In the context of the illustrative embodiments, the cognitive operations may comprise identification of communications that are likely social engineering communications and classifying these communications as to whether or not the communications are social engineering communications based on the content of the communications and extracted features determined to be indicative of social engineering communications.

IBM Watson™ is an example of one such cognitive system which can process human readable language and identify inferences between text passages with human-like high accuracy at speeds far faster than human beings and on a larger scale. In general, such cognitive systems are able to perform the following functions:
Navigate the complexities of human language and understanding
Ingest and process vast amounts of structured and unstructured data
Generate and evaluate hypothesis
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection from data points (images, text, voice) (memorization and recall)
Predict and sense with situational awareness that mimic human cognition based on experiences
Answer questions based on natural language and specific evidence

In one aspect, cognitive systems, in accordance with the illustrative embodiments, provide mechanisms for processing natural language content of documents and communications via a processing pipeline which may include various types of cognitive logic including one or more neural networks, annotators, analytics engines, and other logic to process the documents/communications using natural language processing techniques and pattern recognition mechanisms. The processing pipeline or system is an artificial intelligence application executing on data processing hardware that evaluates the natural language content of these documents/communications as to whether or not the documents/communications are directed to a social engineering communication and/or whether or not the document/communication comprises key extracted features, matches rule criteria, or the like, indicative of a social engineering communication as learned through a machine learning process, as described hereafter. The processing pipeline receives inputs from various sources including input over a network, a corpus of electronic documents or other data, data from a content creator, information from one or more content users, and other such inputs from other possible sources of input. Data storage devices store the corpus/corpora of data. A content creator creates content in a document that may be included as part of a corpus/corpora of data with the processing pipeline. The document may include any file, text, article, or source of data that may be used by the processing pipeline and cognitive computing system. For example, the processing pipeline accesses a body of knowledge about the domain, or subject matter area, e.g., social engineering communications in the illustrative embodiments, where the body of knowledge (knowledgebase) can be organized in a variety of configurations, e.g., a structured repository of domain-specific information, such as ontologies, or unstructured data related to the domain, or a collection of natural language documents about the domain.

The processing pipeline processes content in the corpus/corpora of data by evaluating documents, sections of documents, portions of data in the corpus, or the like, with regard to their semantic and syntactic features. When the processing pipeline evaluates a given section of a document for semantic content, the processing pipeline evaluates the semantic content as to the relation between signifiers, such as words, phrases, signs, and symbols, and what they stand for, their denotation, or connotation. In other words, semantic content is content that interprets an expression, such as by using Natural Language Processing. Syntactic evaluations are directed to the language structure and what it conveys and can be similarly evaluated by the processing pipeline of the cognitive computing system.

The processing pipeline of the cognitive computing system receives an input document, parses the document to extract the major features of the document using a variety of methods including a rule-based algorithm or a sequence labeling machine learning model, uses the extracted features to evaluate the document as to its nature with regard to social engineering communications. The processing pipeline performs deep analysis on the language of the input document's extracted features using a variety of reasoning algorithms which may be implemented as rules based engines, neural networks, or any other cognitive computing logic. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms of a dictionary data structure, rules, templates, or the like, within the language of the input document. Other reasoning algorithms may look at temporal or spatial features in the language, while others may evaluate the source of the document and evaluate its veracity.

The scores obtained from the various reasoning algorithms indicate the classification of the input document based on the specific area of focus of that reasoning algorithm. Each resulting score is then weighted against a statistical model. The statistical model captures how well the reasoning algorithm performed at establishing a correct output during a training operation of the cognitive computing system, e.g. the statistical model may represent weights associated with nodes of neural networks employed by the cognitive computing system. The statistical model is used to summarize a level of confidence that the processing pipeline has regarding the evidence that the input is properly classified into a particular class of input, e.g., social engineering communication or not.

It should be appreciated that this is just an example of a type of cognitive computing system which may be used to implement various aspects of the illustrative embodiments as discussed hereafter. Other types of cognitive computing systems that are able to be trained to recognize patterns of content indicative of social engineering communications may be used with the mechanisms of the illustrative embodiments without departing from the spirit and scope of the present invention.

Thus, in some illustrative embodiments, a cognitive computing system employing natural language processing monitors one or more electronic corpora, which may comprise various sources of content, e.g., blogs, social medial, question and answer systems, electronic sources of security trade information, and various other electronic publications of information associated with information technology and/or information security. The monitoring extracts samples of social networking communications, e.g., fraudulent electronic mail messages, that may be posted in whole, partially, or described in these various portions of electronic content in the one or more corpora (hereafter referred to collectively as “documents” of the corpus or corpora). For example, users may post on electronic website forums, ask questions of question and answer systems, post complaints, etc., regarding social engineering communications they receive and may describe aspects of those social engineering communications, often in an attempt to warn other users to avoid such communications. The cognitive computing system may monitor such posts to identify whether or not the posts are directed to a social engineering communication and if so, what patterns of content are described that may be used to identify other social engineering communications.

In some illustrative embodiments, the monitoring may be based on vector representations of documents in the corpus or corpora generated by a trained cognitive classifier engine computing device that is trained, through a machine learning operation, to identify particular patterns of content indicative of mentions of social networking communications. For example, the trained cognitive classifier engine may be trained to identify particular phrases, terms, or other patterns of content in natural language content, or combinations of different phrases, terms, or patterns present within the natural language content, of the various electronic documents of the corpus or corpora. An electronic document may then be converted to a sparse vector representation of the electronic document which comprises values in each of the vector slots indicating the number of times a particular term, phrase, or pattern is present within the electronic document; or embedded to a dense vector using neural network optimization techniques such as Paragraph Vector or Long-short term memory. These vector representations may be input to the cognitive classifier engine of the illustrative embodiments, which is then trained over a large number of vector representations of these electronic documents, to classify the electronic documents as either relating to, or not relating to, a social engineering communication.

During a training phase of operation, the cognitive classifier engine may be trained using a supervised training operation in which both the inputs and the outputs of the cognitive classifier engine, which in some embodiments may be implemented as a neural network computing model, are provided as a training set of input documents and ground truth data structure specifying the correct output that the cognitive classifier engine should generate. Errors, or loss, in the output of the cognitive classifier engine compared to the ground truth are then propagated back through the cognitive classifier engine causing weights associated with nodes of the neural network computing model, or other operational parameters of the cognitive classifier engine, to be adjusted in an effort to reduce the error between the output generated by the cognitive classifier engine and the ground truth. This process is an iterative process that continues until the error is reduced to below a predetermined threshold at which point the cognitive classifier engine is determined to have been trained, also referred to as convergence.

It should be appreciated, however, that while the cognitive classifier engine is initially trained in this manner, in some illustrative embodiment, the training may continue in a dynamic manner after deployment of the trained cognitive classifier engine as new inputs are received and appropriate feedback is provided to adjust the weights or operational parameters, such as via a reinforcement learning operation. That is, as new communications are processed by the cognitive classifier engine, additional feedback, such as from a subject matter expert, or user such as the recipient of the new communication, may be fed back into the cognitive classifier engine so as to continuously adjust the weights and/or operational parameters to improve the operation of the cognitive classifier engine.

For those documents that are classified as being directed to a social engineering communication, e.g., being a social engineering communication itself or describing a social engineering communication (such as in the case of a posting by a user describing a social engineering communication they have received, for example), any linked documents or files associated with that document may be further processed to extract key features indicative of the social engineering classification. Both the document itself and the linked documents or files are analyzed through feature extraction mechanisms to extract the features indicative of a social engineering communication. This feature extraction may comprise identifying phrases, terms, patterns of text, etc., from key structural portions of the document and/or attached documents/files, features present in metadata associated with these documents/files, or the like. For example, assuming an embodiment in which the document is a social engineering electronic mail (email) communication, such key features may be extracted from the subject of the email, the body of the email, the sender field of the email, and any file attachments to the email. The feature extraction may be implemented using a sequence labeler, such as a feature extractor implementing conditional random field techniques, recurrent neural networks or other statistical modeling technique, for predicting labels for elements of the social engineering communication taking into account the context of the features.

The extracted features may be used to generate a trained social engineering classification model that is trained to look for the extracted features indicative of the social engineering communications and classify the communications as to whether or not the communication is likely a social engineering communication, also referred to as a social engineering attack, or not. Thus, the social engineering classifier processes documents from the various source computing systems to identify which documents are descriptive of a social engineering communication or attack. Then, from the documents that are descriptive of social engineering communications or attacks, key features referenced in such documents, or documents linked to such documents, that are indicative of content of the social engineering communications, are identified and used to configure and train a social engineering classification model.

The social engineering classification model is implemented on one or more data processing systems or computing devices to classify newly incoming communications as to their social engineering communication status, i.e. whether or not the newly incoming communication is likely a social engineering communication or not. These data processing systems may be, for example, electronic mail servers, electronic mail client devices, instant messaging or text messaging servers/client devices, or any other electronic communication computing devices. The social engineering classification model generates a probability score for communications based on the cognitive evaluation of the extracted features that are found in the content of the newly received communications. For example, a weighted evaluation may be performed with regard to the various extracted features, where some extracted features are more highly weighted than others based on the training as to which extracted features are more or less indicative of a social engineering communication. The social engineering classification model may be implemented as a cognitive computing model, such as one or more neural network engines or models, that perform a cognitive evaluation of the content, metadata, etc. of the newly received communications.

In some embodiments, the trained social engineering classification model may be implemented as part of the social engineering classifier engine used to classify electronic documents from the corpus and/or corpora. The processing of the newly received communications by the social engineering classification model may be used, along with user feedback information, to perform further reinforcement learning and fine-tuning of the social engineering classification model and/or the social engineering classifier engine operating on the corpus and/or corpora. For example, the social engineering classification model may indicate that a communication is, or is not, a social engineering communication and the user may respond with a confirmation as to whether the communication is, in their opinion, a social engineering communication or not. This input may be used to modify the operational parameters or weights associated with nodes of the social engineering classification model. Similar training feedback may be provided to the social engineering classifier engine to assist with processing the corpus/corpora used to identify social engineering communications and perform feature extraction.

In some illustrative embodiments, the social engineering classifier engine is a cognitive computing system, e.g., implementing a neural network or the like, that is used to generate the initially trained social engineering model, based on the identification of social engineering communications in a training corpus or corpora, followed by key feature extraction, where the initially trained social engineering model is then deployed to the one or more data processing systems or communication systems or devices. Thereafter, reinforcement learning and fine-tuning of the deployed social engineering model may be implemented at each deployed instance of the social engineering model on their respective data processing systems or communication systems or devices. The reinforcement learning and fine-tuning may be different for each instance based on the particular newly received communications processed by the particular instance of the deployed social engineering model. Coordination among these instances may be facilitated, such as via a centralized computing system, which may receive notifications of newly discovered social engineering communications and the particular extracted features present in these communications and/or the weights/operational parameter adjustments associated with these extracted features. Updates may be pushed from the centralized computing system to instances of the social engineering model when deemed appropriate in accordance with the particular implementation.

In addition, the instances of the social engineering model may initiate responsive actions in response to detecting a newly received communication that is classified as being a social engineering communication. For example, the instance of the social engineering model outputs a classification of the newly received communication as to whether it is a social engineering communication or not. In response to the output indicating a social engineering communication, a process may be initiated to report the social engineering communication to a provider of the social engineering classification model, in which case the report may be added to the training corpus/corpora and/or used to push updates to instances of the social engineering classification model. In some embodiments, the responsive action may comprise deleting the communication, moving the communication to a specific storage location, e.g., a trash folder, a designated social engineering folder, etc., outputting a notification via a graphical user interface, such as an email program interface, warning the user to not respond to the communication or open any attachments, or the like.

Thus, the illustrative embodiments provide mechanisms for training a social engineering classification engine to identify key features in communications that are indicative of whether or not a communication is likely a social engineering communication or not. The training involves identifying electronic documents of one or more source computing systems via one or more data networks which contain social engineering communications, portions thereof, or otherwise describe social engineering communications. Any linked documents associated with these documents from the one or more source computing systems are also processed along with the documents from the source computing systems to extract features indicative of social engineering communications. For example, the characteristics indicative of the documents from the source computing systems may be terms, phrases, or patterns of text that are indicative of a description of a social engineering communication. Key features that may be extracted from these documents include key terms, phrases, or patterns of text that may be contained within social engineering communications and are indicative of the communication being a social engineering communication. It should be appreciated that the characteristics may be key extracted features, and vice versa.

The extracted features are used to configure a cognitive computer model referred to as the social engineering classification (SEC) model, which may be deployed on a plurality of data processing systems, communication systems, or devices that receive electronic communications. The deployed instances of the SEC model may be dynamically trained after deployment and may be used to initiate responsive actions when communications are received that are classified as social engineering communications.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the present invention provides mechanisms for training a social engineering communication cognitive system to identify social engineering communications and initiate responsive actions to such identified social engineering communications. The mechanisms of the illustrative embodiments identify documents present in a variety of different source computing systems that contain or describe social engineering communications or social engineering attacks and their key features, e.g., terms, phrases, patterns of text, metadata, etc. The key features are used to train a social engineering communication model that is deployed to one or more data processing systems, communication systems, and/or devices where the training may be continued dynamically and the model instances may initiated responsive actions to newly received communications classified as social engineering communications.

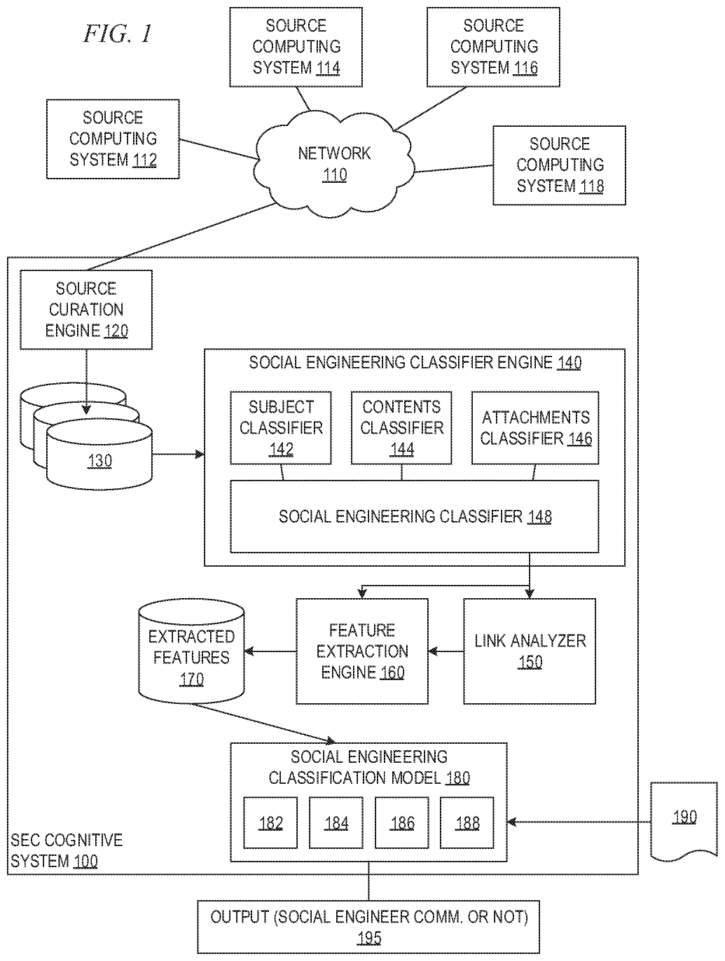

FIG. 1 is an example block diagram illustrating an interaction between functional elements of a social engineering communication (SEC) cognitive system in accordance with one illustrative embodiment. As shown in FIG. 1, the SEC cognitive system 100 may be implemented in a computing or communication device 102 coupled either wired or wirelessly with one or more data networks 110 having one or more electronic document source computing systems 112-118 coupled thereto. The electronic document source computing systems 112-118 may comprise any known or later developed source of electronic content which may include, or describe, social engineering communications. For example, such electronic document source computing systems 112-118 may comprise social networking computing devices, electronic mail servers, electronic document databases or repositories, web sites, various types of crowdsource information sources, company or organization question and answer computing systems, company or organization help line instant messaging or text messaging computing systems, other instant messaging or text messaging systems, or the like. Each of the computing systems 112-118 may comprise one or more computing devices, e.g., server computers, client computers, databases, etc. The types of potential sources of electronic documents in which social engineering communications (or social engineering attacks) may be included or described is voluminous and any such sources are intended to be within the spirit and scope of the present invention, the above being listed as only examples.

The SEC cognitive system 100 comprises a source curation engine 120 which curates documents, which again may be any portion of content provided in an electronic form as one or more data files comprising structured or unstructured content, from the various electronic document source computing systems 112-118. The source curation engine 120 may target a subset of the source computing systems 112-118 or even individual types of documents present in these source computing systems 112-118, e.g., only electronic mail messages, only instant or text messages exchanged with technical assistance help desk computing devices, etc. The source curation engine 120 collects the electronic documents of interest from the various source computing systems 112-118 to generate a corpus or corpora 130 comprising the collected electronic documents which are to be further processed in accordance with the mechanisms of the illustrative embodiments as described herein. In one embodiment, the source curation engine 120 may incorporate features of the social engineering classifier engine 140, such as the classifiers 142-148, where the social engineering classifier 148 may comprise a model trained with a small number of labeled documents to classify SEC-related documents among documents from source computing systems 112-118. This model can use a bootstrap approach that iteratively updates the keywords or features using the already classified documents. In other illustrative embodiments, the social engineering classifier engine 140, and its corresponding classifiers 142-148, may be a separate operational element from the source curation engine 120 which may operate solely as a mechanism for collecting electronic documents of interest from the various source computing systems 112-118 to generate a corpus or corpora 130.

The elements of the SEC cognitive system 100 may implement various types of natural language processing algorithms and logic for analyzing and understanding the terms, phrases, and patterns of text present in the content of the electronic documents collected and provided as part of the corpus or corpora 130. The natural language processing algorithms or logic may be any known or later developed NLP mechanism that identifies elements of natural language text, such as nouns, verbs, adjectives, adverbs, subject, focus, lexical answer types, etc. The NLP mechanisms may be integral to the other elements of the SEC cognitive system 100 shown in FIG. 1 and thus, are not shown as a separate entity in FIG. 1. However, in some illustrative embodiments, the NLP mechanisms may be employed as a separate entity that performs a pre-processing of the documents in the corpus or corpora 130 to convert the documents into a vector representation of the documents in which vector slots of the vector representation represent a recognized vocabulary and values in the vector slots indicate numbers of instances of the corresponding terms, phrases, or portions of text, for example.

The SEC cognitive system 100 further includes a social engineering classifier engine 140 which is trained, such as via a supervised training operation, to identify documents from the corpus or corpora 130 that contain social engineering communications (SECs), portions of SECs, or are otherwise descriptive of SECs and their features. That is, through a supervised training operation the social engineering classifier engine 140 is trained to identify terms, phrases, patterns of text, and/or metadata indicative of documents descriptive of SECs and classifies each input document as to the likelihood that it is reference or describing an SEC. For those documents that are classified as being descriptive of or referencing an SEC, the document is further analyzed by link analyzer 150 to determine if the document contains any linkage to another document, file, or the like, e.g., through a hyperlink, an attachment, or other linking mechanism. The links are followed by the link analyzer 150 to identify the additional documents, files, or the like, that are linked to the SEC descriptive document so that these linked documents may also be analyzed to determine if they correspond to an SEC and if so, may be further analyzed by the feature extraction engine 160 as described hereafter.

In some illustrative embodiments, the social engineering classifier engine 140 may comprise a combination of individual classifiers 142-158 that evaluate various aspects of documents in the corpus or corpora 130 to generate a classification of the document as to whether it is likely an SEC related document or not. For example, a subject classifier 142 may evaluate subject line content of communications included in documents of the corpus or corpora 130 for terms, phrases, and/or patterns of text indicative of an SEC, e.g., terms or combinations of terms like “unauthorized”, “account”, “verification”, etc. A contents classifier 144 may process the contents of the documents to determine if the contents comprise terms, phrases, and/or patterns of text indicative of an SEC. The attachment classifier 146 may perform similar classification operations on linked documents or attachments associated with the document in the corpus or corpora 130. These classifiers 142-146 may utilize natural language processing algorithms or logic to assist with the analysis of the respective portions of the document and/or linked documents or attachments. Moreover, each of these classifiers 142-146 and the social engineering classifier 148 may be implemented as a neural network trained through a supervised machine learning operation. Moreover, additional classifiers, in addition to or in replacement of those shown in FIG. 1, may be implemented without departing from the spirit and scope of the present invention.

The classification outputs of these classifiers 142-146 may be vector outputs indicating probability values based on various classes the classifiers 142-146 are trained to recognize. The outputs of these classifiers 142-146 may be input to the social engineering classifier 148 that combines the classification outputs from these classifiers 142-146 and applies trained logic to these classification outputs to generate a final determination as to whether the document and/or linked documents are associated with an SEC or not. Thus, the social engineering classifier engine 140 outputs an indication as to whether a document in the corpus or corpora 130 is associated with an SEC either by including the SEC, a portion of the SEC, or otherwise describing or referencing an SEC.

For those documents from the corpus/corpora 130 classified as being directed to an SEC, the feature extraction engine 160 extracts key features from the document, e.g., a posting to a website, forum, or the like, and any documents linked to that document, e.g., a hyperlink linking the document to the actual social engineering communication. That is, for those documents that are classified as being directed to a social engineering communication by the social engineering classifier engine 140, e.g., being a social engineering communication itself or describing a social engineering communication (such as in the case of a posting by a user describing a social engineering communication they have received, for example), any linked documents or files associated with that document may be further processed to extract key features indicative of the social engineering classification. Both the document itself and the linked documents or files are analyzed through feature extraction mechanisms to extract the features indicative of a social engineering communication. This feature extraction may comprise identifying phrases, terms, patterns of text, etc., from key structural portions of the document and/or attached documents/files, features present in metadata associated with these documents/files, or the like. For example, assuming an embodiment in which the document is a social engineering electronic mail (email) communication, such key features may be extracted from the subject of the email, the body of the email, the sender field of the email, and any file attachments to the email. The feature extraction performed by the feature extraction engine 160 may be implemented using a sequence labeler, such as a feature extractor implementing conditional random field techniques or other statistical modeling technique, for predicting labels for elements of the social engineering communication taking into account the context of the features, as previously mentioned above.

The extracted features 170 may be used to generate key feature patterns or rules that may specify the patterns of content indicative of an SEC. For example, rules may be specified that generalize the extracted features for applicability to general communications by replacing any personalized tokens in the SEC with generalized tokens, e.g., replacing a specific user's electronic mail address, name, account identifier, address, etc., in the extracted features with a corresponding generalized token, e.g., “<user email>”, “<user name>”, “<user account number>”, “<user address>”, etc. Thus, for example, a rule may specify a combination of key features in context with one another and the generalized token to specify a pattern indicative of social engineering communications, e.g., “<User Name>, ‘account hacked’ or ‘account vulnerable’ or ‘account accessed’, and ‘by unknown party.’”

The extracted features may be used to configure and/or train a social engineering classification model 180. In some illustrative embodiments, the social engineering classification model 180 may be implemented as a rules engine that applies the rules associated with the extracted features 170 to determine if portions of content of a newly incoming communication match the criteria of the rules. In some cases, a fuzzy matching approach may be utilized to determine a degree of matching of the content of the newly incoming communication 190 to the various rules associated with the extracted features 170, where if the degree of matching is above a predetermined threshold level of matching, then it is determined that the rule has been matched, i.e. the criteria of the rule have been satisfied by the content of the new communication 190. It should be appreciated that the rules may target specific structured portions of the communication 190, e.g., source address, subject line, metadata associated with the communication, etc. and/or unstructured portions of the communication 190, e.g., a body of the communication.

In addition to, or alternative to, the rules based engine, a trained cognitive computing system may be used to implement the social engineering classification model 180. For example, the social engineering classification model 180 may implement one or more neural networks whose nodes are configured to look for particular ones of the extracted features 170. Weights associated with these nodes may be set based on a supervised training of the social engineering classification model 180 in a similar manner as the social engineering classifier engine 140. As with the social engineering classifier engine 140, the social engineering classification model may comprise individual classifiers 182-188 that are configured to evaluate extracted features 170 associated with various portions of newly incoming communications 190, e.g., the source address, subject matter line, body of the communication, metadata, etc. Thus, based on the training, depending on which key extracted features 170 are found in the newly incoming communication 190, the newly incoming communication 190 is classified as a social engineering communication (SEC) or not. This determination may be a binary output 195 indicating SEC or not, or may be a probability value indicating a probability score as generated by the cognitive computing system of the social engineering classification model 180 indicating a probability that the incoming communication 190 is an SEC or not.

In some illustrative embodiments, the social engineering classification model 190 may comprise both a rules based engine and a cognitive computing system, such as a neural network, that operates to classify newly incoming communications 190 as to whether they are likely SECs or not. In such a case, the output of the rules based engine indicates the rules that are matched by the content of the newly incoming communication 190 and the cognitive computing system evaluates the outputs using weighted evaluations to determine based on which rules are matched and which rules are not matched by the incoming communication 190, whether the incoming communication 190 has a sufficiently high probability, e.g., equal to or above a predetermined threshold probability value or score, to determine that the new incoming communication 190 is an SEC.

The social engineering classification model 180 may be implemented on one or more data processing systems or computing devices to classify newly incoming communications 190 as to their social engineering status. These data processing systems may be, for example, electronic mail servers, electronic mail client devices, instant messaging or text messaging servers/client devices, or any other electronic communication computing devices. The social engineering classification model 180 generates the probability score for communications based on the cognitive evaluation of the extracted features 170 that are found in the content of the newly received communications 190, which may include a weighted evaluation with regard to the various extracted features, where some extracted features are more highly weighted than others based on a the training as to which extracted features are more or less indicative of a social engineering communication, either alone or in combination with other extracted features.

The output 195 generated by the social engineering classification model 180 may be provided to a responsive action engine 198 which performs a responsive action in response to the output 195 indicating that the incoming new communication 190 is an SEC. This response may take many different forms depending on the desired implementation. For example, the response may involve sending a notification to an authorized user, sending the notification to a governmental regulation agency, or any other authorized party, indicating the nature of the SEC attack, potentially including a copy of the new communication 190 content illustrating the SEC nature of the communication, and including reasoning as to why the communication is determined to be an SEC by the social engineering classification model 180, e.g., the probability score, the criteria of the matching rules that are satisfied, etc. In some illustrative embodiments, the responsive action may additionally, or alternatively, include deleting the communication 190 from a storage, directing the storage of the communication 190 to a specific location in a storage system, e.g., a particular folder, or the like. In some illustrative embodiments, the responsive action may additionally, or alternatively, include sending a notification to the recipient of the new communication 190 to warn them of the potential that the communication 190 is an SEC and to not respond to the communication or interact with any hyperlinks, open any attachments, or otherwise interact with any other graphical user interface elements of the communication. Such warnings may be output on a client device associated with the user in response to determining the communication 190 to be a social engineering communication by the social engineering classification model 180.

In some embodiments, the trained social engineering classification model 190 may be implemented as part of the social engineering classifier engine 140 used to classify electronic documents from the corpus and/or corpora 130. The processing of the newly received communications 190 by the social engineering classification model 180 may be used, along with user feedback information, such as from the recipient of the new communication 190, confirming or not confirming the output 195 of the social engineering classification model 180, to perform further dynamic training of the social engineering classification model 180 and/or the social engineering classifier engine 140 operating on the corpus and/or corpora 130. For example, the social engineering classification model 180 may indicate that a communication 190 is, or is not, a social engineering communication in the output 195 and the user may respond with a confirmation as to whether the communication is, in their opinion, a social engineering communication or not. This input may be used to modify the operational parameters or weights associated with nodes of the social engineering classification model 180. Similar training feedback may be provided to the social engineering classifier engine 140 to assist with processing the corpus/corpora 130 used to identify social engineering communications and perform feature extraction via the feature extraction engine 160.

In some illustrative embodiments, the social engineering classifier engine 130 is a cognitive computing system, e.g., implementing a neural network or the like, that is used to generate the initially trained social engineering classification model 180, based on the identification of social engineering communications in a training corpus or corpora 130, followed by key feature extraction by the feature extraction engine 160, where the initially trained social engineering model 180 is then deployed to the one or more data processing systems or communication systems or devices, e.g., email servers, email clients, instant or text message servers/clients, or the like. Thereafter, dynamic training of the deployed social engineering model 180 may be implemented at each deployed instance of the social engineering model 180 on their respective data processing systems or communication systems or devices. The dynamic training may be different for each instance based on the particular newly received communications processed by the particular instance of the deployed social engineering model 180. Coordination among these instances may be facilitated, such as via a centralized computing system (not shown), which may receive notifications of newly discovered social engineering communications and the particular extracted features present in these communications and/or the weights/operational parameter adjustments associated with these extracted features. Updates may be pushed from the centralized computing system to instances of the social engineering model 180 when deemed appropriate in accordance with the particular implementation.

It should be appreciated that the present invention operates to identify social engineering communications which are significantly different from other types of communications for which filters and scanning algorithms/logic are provided. For example, key differences between social engineering communications and SPAM communications are that social engineering communications tend to be directed to a small set of recipients, are personalized to the particular recipient, and attempt to emulate actual communications that a user may be involved in to thereby fool the recipient into responding, whereas SPAM communications are sent to a relatively large number of recipients, are not personalized to the recipient, and are crafted primarily to circumvent filters. Moreover, as noted above, virus spreading communications are generally composed to cause a user to unwittingly permit a program or code to be executed on the recipient computing device and are crafted to avoid virus scanning algorithms/logic.

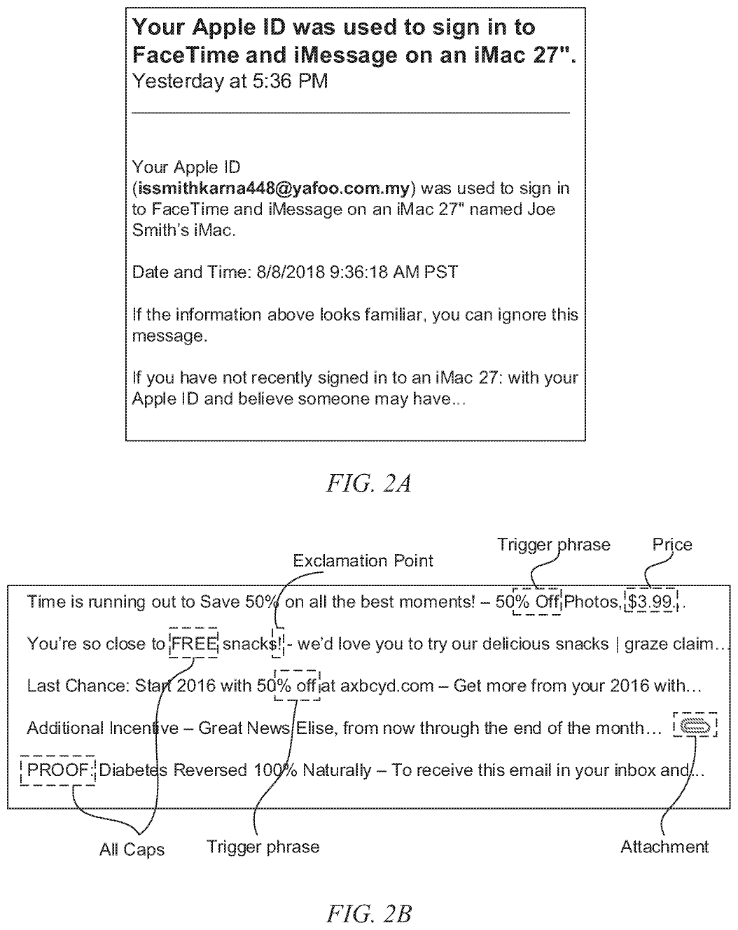

FIG. 2A illustrates an example of content of a social engineering communication while FIG. 2B illustrates an example of content of a SPAM communication. As can be seen in FIG. 2A, the communication is personalized to the particular account ID of the recipient, indicates a social networking service used by the recipient, and identifies a specific computing device. The communication is further crafted to allegedly provide the user with the ability to ignore the communication if the information looks correct, however the attacker knows the information to be incorrect and thus, the recipient is likely to be lulled into a sense of trust of the communication since the communication appears to be valid and appears to acknowledge that the communication could be ignored. To the contrary, the communication in FIG. 2B is not personalized to the recipient and has textual elements that make it difficult for SPAM filters to identify the communication as being SPAM, e.g., adding punctuation marks, all capitalized words, etc.

As noted above, the illustrative embodiments include a social engineering classifier engine 140 that classifies documents in a corpus/corpora 130 as to whether they are likely referencing, describing, or otherwise include at least a portion of an SEC. In some illustrative embodiments, these documents comprise user postings to forums, blogs, social networking sites, technical assistance computing systems, or the like, where users include or describe SECs, often complaining about such SECs. FIG. 2C is an example diagram illustrating one type of document, e.g., posting, that may be analyzed by the social engineering classifier engine 140 in this manner. As shown in FIG. 2C, the document comprises a posting by Racco42 indicating a phishing campaign referred to as “Bills” and includes a link to the content of an example of one of these phishing communications. With the mechanisms of the illustrative embodiments, the social engineering classifier engine 140 may analyze both the document (e.g., posting) itself and the linked document (e.g., the example content of the SEC) to determine if the document and/or linked document is referencing an SEC and if so, extract features indicative of the SEC for use in configuring and training the social engineering classification model 180.

FIG. 2D is another example of a document that may be part of the corpus/corpora 130 which may be analyzed to identify SECs and train the social engineering classification model 180 with regard to key extracted features of such SECs. In this example, the document is an electronic mail message from a sender warning others of the SEC communication. From the content of the document, the extracted features indicate that the SEC pretends to be “Music Warehouse” but is sent from a source that is referred to as “Musaik Warehouse” and that the SEC alleges that the user's subscription is being paused until they enter billing information. These features may be extracted from the email shown in FIG. 2D and used as extracted features for generating rules and/or training the cognitive computing system of the social engineering classification model 180. In addition, the email comprises an attachment with the original SEC which can also be evaluated using the mechanisms of the illustrative embodiments to extract key features of the SEC.

Thus, the mechanisms of the illustrative embodiments leverage cognitive computing mechanisms to learn patterns of content of communications from a variety of different sources, which are indicative of social engineering communications, i.e. communications whose content is intended to manipulate individuals into divulging confidential or personal information that may be used for fraudulent purposes. These mechanisms may dynamically learn such patterns from the variety of different sources and apply the learned patterns to newly received communications to classify these newly received communications as to the likelihood that they are a social engineering communication or not. A responsive action may then be taken based on the classification. In this way, users are given greater protections against social engineering communications than are presently available by being able to identify these communications and warn users of their potentially harmful nature.

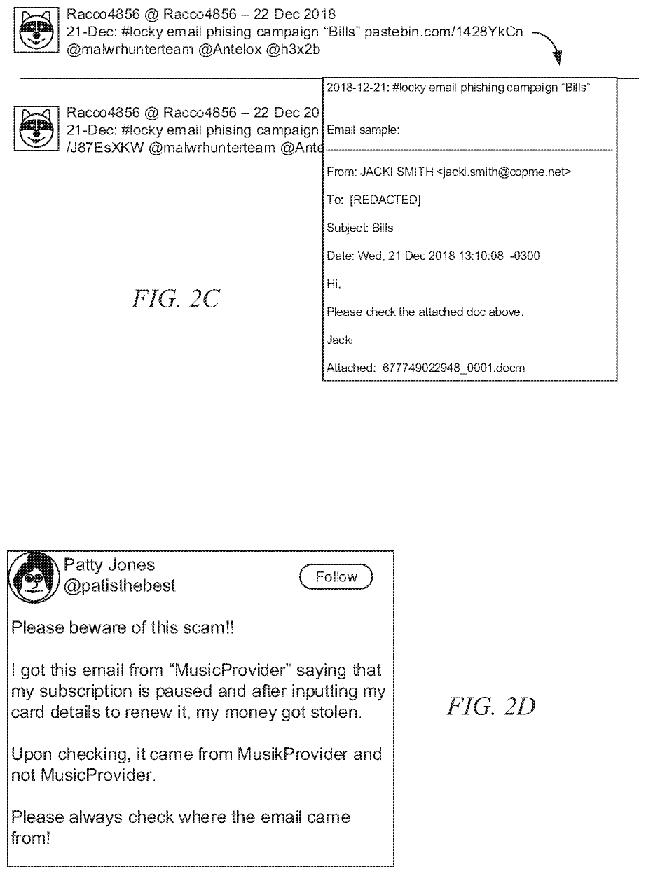

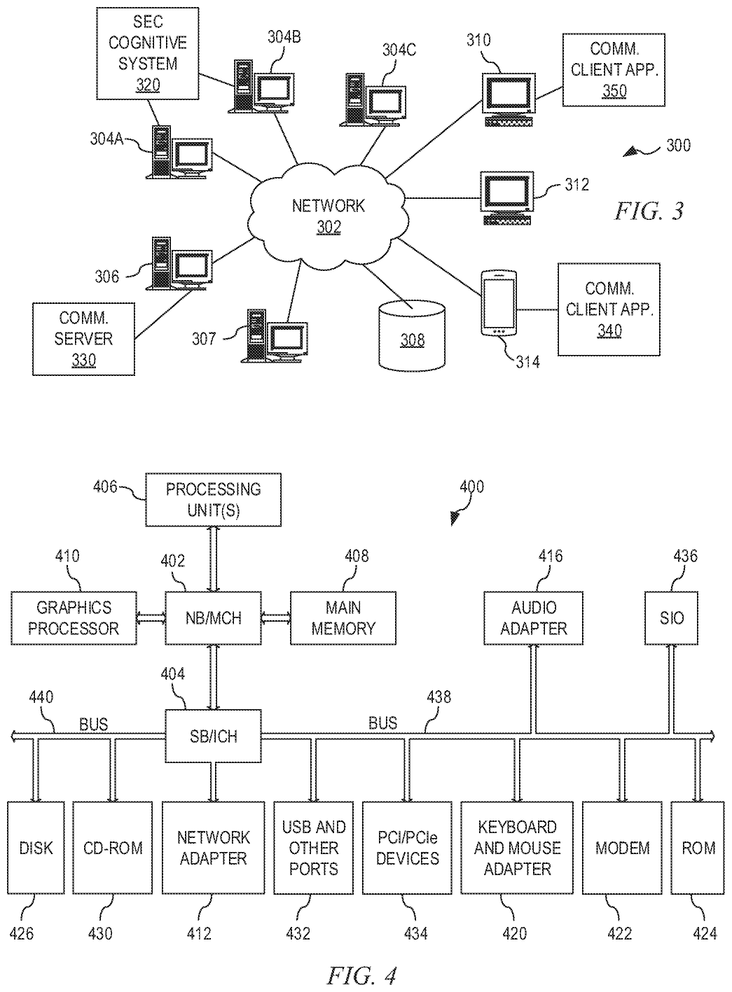

It is clear from the above that the illustrative embodiments are specifically directed to an improved computing tool that provides new computer functionality for analyzing communications, classifying them as to whether they are social engineering communications or not, and performing responsive actions based on such classifications. Moreover, the mechanisms of the illustrative embodiments generate a social engineering classification model that may be deployed to many different types of computing devices or systems, and may dynamically update its own training based on new communications encountered. Thus, those of ordinary skill in the art will recognize that the illustrative embodiments may be utilized in many different types of data processing environments. In order to provide a context for the description of the specific elements and functionality of the illustrative embodiments, FIGS. 3-4 are provided hereafter as example environments in which aspects of the illustrative embodiments may be implemented. It should be appreciated that FIGS. 3-4 are only examples and are not intended to assert or imply any limitation with regard to the environments in which aspects or embodiments of the present invention may be implemented. Many modifications to the depicted environments may be made without departing from the spirit and scope of the present invention.

FIG. 3 depicts a pictorial representation of an example distributed data processing system in which aspects of the illustrative embodiments may be implemented. Distributed data processing system 300 may include a network of computers in which aspects of the illustrative embodiments may be implemented. The distributed data processing system 300 contains at least one network 302, which is the medium used to provide communication links between various devices and computers connected together within distributed data processing system 300. The network 302 may include connections, such as wire, wireless communication links, fiber optic cables, or the like.

In the depicted example, servers 304A-304C and servers 306, 307 are connected to network 302 along with network attached storage unit 308. In addition, client computing devices 310, 312, and 314 are also connected to network 302. These clients 310, 312, and 314 may be, for example, personal computers, network computers, portable computing devices implemented in communication devices (e.g., smart phones), or the like. In the depicted example, servers 304A-304C, 306, and 307 may provide data, operating system images, and applications to the clients 310, 312, and 314. Clients 310, 312, and 314 are clients to these servers 304A-304C, 306, and 307 in the depicted example. Distributed data processing system 300 may include additional servers, clients, and other devices, e.g., network traffic and security computing devices such as routers, firewalls, and the like, not shown.

In the depicted example, distributed data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 300 may also be implemented to include a number of different types of networks, such as for example, an intranet, a local area network (LAN), a wide area network (WAN), or the like. As stated above, FIG. 3 is intended as an example, not as an architectural limitation for different embodiments of the present invention, and therefore, the particular elements shown in FIG. 3 should not be considered limiting with regard to the environments in which the illustrative embodiments of the present invention may be implemented.

As shown in FIG. 3, one or more of the computing devices, e.g., one or more of servers 304A and 304B, may be specifically configured to implement an SEC cognitive system 320 that operates in a manner such as previously described above with regard to FIG. 1. Moreover, as described previously, the SEC cognitive system 320 generates and trains a social engineering communication classification model that is deployed to one or more other computing devices, e.g., server 306, client devices 310 and 314, or the like, and thereby configures those computing devices to implement the social engineering communication classification model that is deployed, as well as its dynamic machine learning training capabilities. The configuring of the computing devices may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 304A-304B, 306 and clients 310 and 314, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing devices are configured in one of these ways, the computing devices become specialized computing devices specifically configured to implement the mechanisms of the illustrative embodiments and are not a general purpose computing device. Moreover, as described hereafter, the implementation of the mechanisms of the illustrative embodiments improves the functionality of the computing devices and provides a useful and concrete result that facilitates identifying social engineering communications and performing responsive actions to increase the security of users of communication systems by performing responsive actions that reduce risks to the users.

As noted above, the mechanisms of the illustrative embodiments utilize specifically configured computing devices, or data processing systems, to perform the operations for cognitively identifying social engineering communications and performing responsive actions in response to the identification of such social engineering communications. The mechanisms of the illustrative embodiments further provide mechanisms for training the cognitive engines that perform the operations for identifying such social engineering communications. These computing devices, or data processing systems, may comprise various hardware elements which are specifically configured, either through hardware configuration, software configuration, or a combination of hardware and software configuration, to implement one or more of the systems/subsystems described herein.

In accordance with the illustrative embodiments, one or more the servers, client computing devices 310-314, or the like, may implement one or more of the mechanisms of a social engineering communication (SEC) cognitive system, such as elements of the SEC cognitive system 100 in FIG. 1. For example, in one illustrative embodiment, the source curation engine 120, document corpus/corpora 130, social engineering classifier 140, link analyzer 150, and key feature extraction engine 160 may be implemented in one or more server computing devices 304A-304B. These elements may operate in the manner previously described above with reference to FIG. 1 to generate an initially trained social engineering communication classification model 180. The SEC cognitive system 320 may train the social engineering communication classification model 180 based on features extracted from documents, and any linked documents, of a corpus/corpora that is compiled by a curation engine from a variety of different sources, such as network attached storage 308, server 307, server 304C, clients 310-314, or any other computing system or device coupled to the network 302 which may be a source of documents for consideration by the curation engine for inclusion in the corpus/corpora.

The initially trained social engineering communication classification model 180 may then be deployed to other servers, such as communication (e.g., email, instant messaging, text messaging, etc.) server 330 on physical server computing device 306, client computing devices 310 and 312 working in conjunction with communication client applications 340, 350, or the like for execution on newly received communications, e.g., emails, instant messages, text messages, or the like, depending on the nature of the communications which the social engineering communication classification model 180 is configured to evaluate. As noted previously, once deployed, the instances of the social engineering communication classification model 180 may be dynamically trained based on newly received communications and user feedback from a user of the client computing device to dynamically modify the operation of the social engineering communication classification model 180. Moreover, the training may be facilitated on other instances through a centralized computing system, such as a server 304A or 304B, which may receive updates to training from the various instances of the social engineering communication classification model 180 and pushed to other instances when such updates are deemed to be of such a nature as to warrant distribution to other instances.

Moreover, as noted above, the instances of the social engineering communication classification model 180 may further interface with responsive action engines, provided on the various computing devices, e.g., servers, client devices, or the like, in order to perform responsive actions for protecting users from possible social engineering communications. For example, the responsive actions engines may be provided as part of the communication server 330, the communication client apps 340, 350, or provided as a separate logic module on these computing/communication devices. These responsive actions, as noted above, may be the sending of notifications, blocking of communications, redirecting the communications to specific storage locations, deleting communications, or the like.

FIG. 4 is a block diagram of an example data processing system in which aspects of the illustrative embodiments are implemented. Data processing system 400 is an example of a computer, such as server 304A-304D or client 310 in FIG. 3, in which computer usable code or instructions implementing the processes for illustrative embodiments of the present invention are located. In one illustrative embodiment, FIG. 4 represents a server computing device, such as a server 304A, which implements an SEC cognitive system 100 comprising a processing pipeline augmented to include the various elements of the illustrative embodiments described herein.

In the depicted example, data processing system 400 employs a hub architecture including north bridge and memory controller hub (NB/MCH) 402 and south bridge and input/output (I/O) controller hub (SB/ICH) 404. Processing unit 406, main memory 408, and graphics processor 410 are connected to NB/MCH 402. Graphics processor 410 is connected to NB/MCH 402 through an accelerated graphics port (AGP).

In the depicted example, local area network (LAN) adapter 412 connects to SB/ICH 404. Audio adapter 416, keyboard and mouse adapter 420, modem 422, read only memory (ROM) 424, hard disk drive (HDD) 426, CD-ROM drive 430, universal serial bus (USB) ports and other communication ports 432, and PCI/PCIe devices 434 connect to SB/ICH 404 through bus 438 and bus 440. PCI/PCIe devices may include, for example, Ethernet adapters, add-in cards, and PC cards for notebook computers. PCI uses a card bus controller, while PCIe does not. ROM 424 may be, for example, a flash basic input/output system (BIOS).

HDD 426 and CD-ROM drive 430 connect to SB/ICH 404 through bus 440. HDD 426 and CD-ROM drive 430 may use, for example, an integrated drive electronics (IDE) or serial advanced technology attachment (SATA) interface. Super I/O (SIO) device 436 is connected to SB/ICH 404.

An operating system runs on processing unit 406. The operating system coordinates and provides control of various components within the data processing system 400 in FIG. 4. As a client, the operating system is a commercially available operating system such as Microsoft® Windows10®. An object-oriented programming system, such as the Java™ programming system, may run in conjunction with the operating system and provides calls to the operating system from Java™ programs or applications executing on data processing system 400.

As a server, data processing system 400 may be, for example, an IBM® eServer™ System p® computer system, running the Advanced Interactive Executive) (AIX® operating system or the LINUX® operating system. Data processing system 400 may be a symmetric multiprocessor (SMP) system including a plurality of processors in processing unit 406. Alternatively, a single processor system may be employed.

Instructions for the operating system, the object-oriented programming system, and applications or programs are located on storage devices, such as HDD 426, and are loaded into main memory 408 for execution by processing unit 406. The processes for illustrative embodiments of the present invention are performed by processing unit 406 using computer usable program code, which is located in a memory such as, for example, main memory 408, ROM 424, or in one or more peripheral devices 426 and 430, for example.

A bus system, such as bus 438 or bus 440 as shown in FIG. 4, is comprised of one or more buses. Of course, the bus system may be implemented using any type of communication fabric or architecture that provides for a transfer of data between different components or devices attached to the fabric or architecture. A communication unit, such as modem 422 or network adapter 412 of FIG. 4, includes one or more devices used to transmit and receive data. A memory may be, for example, main memory 408, ROM 424, or a cache such as found in NB/MCH 402 in FIG. 4.

Those of ordinary skill in the art will appreciate that the hardware depicted in FIGS. 3 and 4 may vary depending on the implementation. Other internal hardware or peripheral devices, such as flash memory, equivalent non-volatile memory, or optical disk drives and the like, may be used in addition to or in place of the hardware depicted in FIGS. 3 and 4. Also, the processes of the illustrative embodiments may be applied to a multiprocessor data processing system, other than the SMP system mentioned previously, without departing from the spirit and scope of the present invention.

Moreover, the data processing system 400 may take the form of any of a number of different data processing systems including client computing devices, server computing devices, a tablet computer, laptop computer, telephone or other communication device, a personal digital assistant (PDA), or the like. In some illustrative examples, data processing system 400 may be a portable computing device that is configured with flash memory to provide non-volatile memory for storing operating system files and/or user-generated data, for example. Essentially, data processing system 400 may be any known or later developed data processing system without architectural limitation.

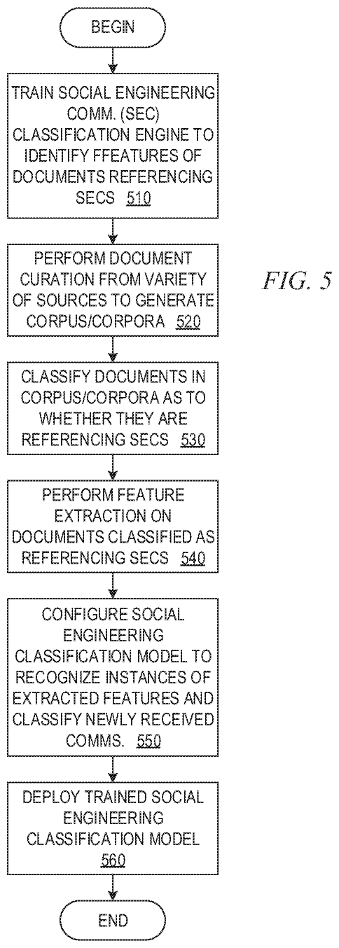

FIG. 5 is a flowchart outlining an example operation for training and deploying a social engineering classification model in accordance with one illustrative embodiment. As shown in FIG. 5, the operation uses a training corpus/corpora to train a social engineering communication classification engine to identify features of documents and/or linked documents, that are indicative of documents referencing, including a portion of, or otherwise describing a social engineering communication (step 510). The social engineering communication classification engine is trained using a supervised training operation using the training corpus/corpora and either manual feedback from a subject matter expert or from a golden or ground truth. A curation engine performs a document curation operation to obtain documents from a variety of different source computing systems and generate a corpus/corpora of documents (step 520). The corpus/corpora is input to the trained social engineering communication classification engine which classifies each of the documents as to whether they are likely associated with a social engineering communication (SEC) or not (step 530). Those documents classified as being associated with an SEC are further analyzed to extract key features indicative of SECs (step 540).

The extracted key features are used to configure a social engineering classification model to recognize instances of these extracted key features in newly incoming communications and classify newly received communications as to whether they are SECs or not (step 550). The trained social engineering classification model may then be deployed to one or more computing devices for execution against newly incoming communications (step 560). The operation then terminates.

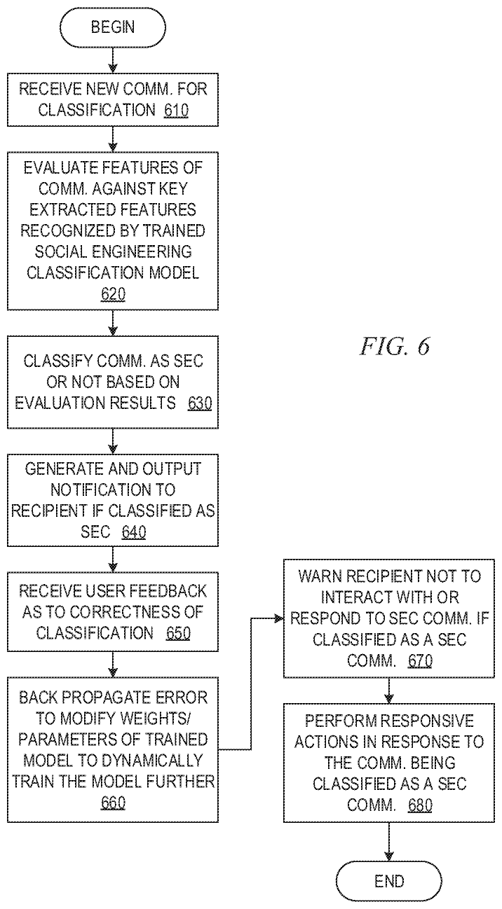

FIG. 6 is a flowchart outlining an example operation for executing a trained social engineering classification model and performing dynamic training of the model in accordance with one illustrative embodiment. As shown in FIG. 6, the operation starts by receiving a new communication for classification (step 610). The new communication is input to the trained social engineering classification model which evaluates features of the communication against extracted key features (step 620). Based on the training of the model and the particular combination of key features present in the newly incoming communication, the trained model classifies the new communication as to whether it is likely an SEC or not (step 630). The output of the classification may be used to generate a notification to a recipient of the communication informing them of the classification generated by the model (step 640). User feedback may be received back indicating whether or not the classification was correct or not (step 650). Based on the user feedback, any error is back propagated to the model to modify its weights or other operational parameters to reduce the error (step 660). Moreover, the notification may inform the recipient and warn them to not interact with elements of the communication or respond to the communication (step 670). Appropriate responsive actions may be performed to reduce the risk to the recipient, such as deleting the communication, blocking the communication, redirecting the communication, sending a notification to an authorized party or organization, or the like (step 680). The operation then terminates.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, the at least one memory comprising instructions executed by the at least one processor to cause the at least one processor to implement a social engineering cognitive system, the method comprising:
training, by the social engineering cognitive system, a social engineering classifier to classify documents in a corpus as to whether they are associated with a social engineering communication (SEC);
processing, by the social engineering cognitive system, one or more documents of the corpus to classify the one or more documents as to whether the one or more documents are associated with an SEC to thereby identify a set of SEC related documents;
extracting, by the social engineering cognitive system, key features from the SEC related documents in the set of SEC related documents;
training, by the social engineering cognitive system, an SEC classification model based on the extracted key features;
processing, by the trained SEC classification model, a newly received electronic communication to determine whether or not the newly received electronic communication is an SEC; and
performing, by a computing device, a responsive action in response to determining that the newly received electronic communication is an SEC.

2. The method of claim 1, wherein extracting key features from the SEC related documents in the set of SEC related documents comprises processing at least one of a linked document linked to an SEC related document, or a linked file linked to the SEC related document, to extract features present in the linked document or linked file that are indicative of an SEC.

3. The method of claim 1, wherein extracting key features from the SEC related documents in the set of SEC related documents comprises extracting, from key structural portions of the documents in the set of SEC related documents, at least one of phrases, terms, or patterns of text, or features present in metadata associated with the documents in the set of SEC related documents.

4. The method of claim 1, wherein extracting key features from the SEC related documents comprises processing the SEC related documents by a feature extractor implementing at least one of a conditional random field operation, a recurrent neural network operation, or statistical modeling operation, to predict labels for elements of the SEC related documents indicative of an SEC.

5. The method of claim 1, wherein processing, by the trained SEC classification model, the newly received electronic communication to determine whether or not the newly received electronic communication is an SEC comprises:
extracting features from the newly received electronic communication; and
performing a weighted evaluation of the extracted features from the newly received electronic communication in accordance with weights defined in the trained SEC classification model, to generate a probability score for the newly received communication indicating a probability that the newly received electronic communication is an SEC.

6. The method of claim 5, wherein the weights defined in the trained SEC classification model are machine learned weights associated with features of electronic communications that indicate a relative importance of extracted features in determining whether or not electronic communications are SECs.

7. The method of claim 1, further comprising:
notifying, by the social engineering cognitive system, a user of results of processing the newly received electronic communication to determine whether or not the newly received electronic communication is an SEC;
receiving, by the social engineering cognitive system, user feedback in response to the notification, wherein the user feedback indicates a correctness or incorrectness of the results of the processing of the newly received electronic communication; and
updating, by the social engineering cognitive system, training of the trained SEC classification model based on the user feedback.

8. The method of claim 1, wherein the responsive action is an operation executed by the computing device to mitigate negative effects of the newly received electronic communication with regard to at least one of an operation of the computing device or access to personal information of a user of the computing device.

9. The method of claim 1, wherein the responsive action is at least one of deleting the newly received electronic communication, moving the newly received electronic communication to a specific storage location, outputting a notification warning a user to not respond to the newly received electronic communication or open any attachments associated with the newly received communication, or reporting the newly received electronic communication to a provider of the trained SEC classification model.

10. The method of claim 1, wherein processing the newly received electronic communication to determine whether or not the newly received electronic communication is an SEC comprises:
deploying, by the social engineering cognitive system, the trained SEC classification model to the computing device via at least one data network; and
executing, by the computing device, the SEC classification model in association with a communication application executing on the computing device, to classify communications received by the communication application.

11. A computer program product comprising a computer readable storage medium having a computer readable program stored therein, wherein the computer readable program, when executed in a data processing system, configures the data processing system to implement a social engineering cognitive system and operate to:
train, by the social engineering cognitive system, a social engineering classifier to classify documents in a corpus as to whether they are associated with a social engineering communication (SEC);
process, by the social engineering cognitive system, one or more documents of the corpus to classify the one or more documents as to whether the one or more documents are associated with an SEC to thereby identify a set of SEC related documents;
extract, by the social engineering cognitive system, key features from the SEC related documents in the set of SEC related documents;
train, by the social engineering cognitive system, an SEC classification model based on the extracted key features;
process, by the trained SEC classification model, a newly received electronic communication to determine whether or not the newly received electronic communication is an SEC; and
perform, by a computing device, a responsive action in response to determining that the newly received electronic communication is an SEC.

12. The computer program product of claim 11, wherein the computer readable program further causes the data processing system to extract key features from the SEC related documents in the set of SEC related documents at least by processing at least one of a linked document linked to an SEC related document, or a linked file linked to the SEC related document, to extract features present in the linked document or linked file that are indicative of an SEC.

13. The computer program product of claim 11, wherein the computer readable program further causes the data processing system to extract key features from the SEC related documents in the set of SEC related documents at least by extracting, from key structural portions of the documents in the set of SEC related documents, at least one of phrases, terms, or patterns of text, or features present in metadata associated with the documents in the set of SEC related documents.

14. The computer program product of claim 11, wherein the computer readable program further causes the data processing system to extract key features from the SEC related documents at least by processing the SEC related documents by a feature extractor implementing at least one of a conditional random field operation, a recurrent neural network operation, or statistical modeling operation, to predict labels for elements of the SEC related documents indicative of an SEC.

15. The computer program product of claim 11, wherein the computer readable program further causes the data processing system to process, by the trained SEC classification model, the newly received electronic communication to determine whether or not the newly received electronic communication is an SEC at least by:
extracting features from the newly received electronic communication; and
performing a weighted evaluation of the extracted features from the newly received electronic communication in accordance with weights defined in the trained SEC classification model, to generate a probability score for the newly received communication indicating a probability that the newly received electronic communication is an SEC.

16. The computer program product of claim 15, wherein the weights defined in the trained SEC classification model are machine learned weights associated with features of electronic communications that indicate a relative importance of extracted features in determining whether or not electronic communications are SECs.

17. The computer program product of claim 11, wherein the computer readable program further causes the data processing system to:
notify, by the social engineering cognitive system, a user of results of processing the newly received electronic communication to determine whether or not the newly received electronic communication is an SEC;
receive, by the social engineering cognitive system, user feedback in response to the notification, wherein the user feedback indicates a correctness or incorrectness of the results of the processing of the newly received electronic communication; and
update, by the social engineering cognitive system, training of the trained SEC classification model based on the user feedback.

18. The computer program product of claim 11, wherein the responsive action is an operation executed by the computing device to mitigate negative effects of the newly received electronic communication with regard to at least one of an operation of the computing device or access to personal information of a user of the computing device.

19. The computer program product of claim 11, wherein the responsive action is at least one of deleting the newly received electronic communication, moving the newly received electronic communication to a specific storage location, outputting a notification warning a user to not respond to the newly received electronic communication or open any attachments associated with the newly received communication, or reporting the newly received electronic communication to a provider of the trained SEC classification model.

20. A data processing system comprising:
at least one processor; and
at least one memory coupled to the at least one processor, wherein the at least one memory comprises instructions which, when executed by the at least one processor, cause the data processing system to implement a social engineering cognitive system and operate to:
train, by the social engineering cognitive system, a social engineering classifier to classify documents in a corpus as to whether they are associated with a social engineering communication (SEC);
process, by the social engineering cognitive system, one or more documents of the corpus to classify the one or more documents as to whether the one or more documents are associated with an SEC to thereby identify a set of SEC related documents;
extract, by the social engineering cognitive system, key features from the SEC related documents in the set of SEC related documents;
train, by the social engineering cognitive system, an SEC classification model based on the extracted key features;
process, by the trained SEC classification model, a newly received electronic communication to determine whether or not the newly received electronic communication is an SEC; and
perform, by a computing device, a responsive action in response to determining that the newly received electronic communication is an SEC.
